(19) United States
(12) Patent Application Publication
(10) Pub. No.: US 2016/0194969 A1
(43) Pub. Date: Jul. 7, 2016

(54) Turbine Vane With Platform Rib

(71) Applicant: UNITED TECHNOLOGIES CORPORATION, Hartford, CT (US)

(72) Inventors: John T. OLS, Northborough, MA (US); Richard N. ALLEN, West Hartford, CT (US); Steven D. PORTER, Wethersfield, CT (US); Paul K. SANCHEZ, Wellington, FL (US)

(21) Appl. No.: 14/917,124

(22) PCT Filed: Sep. 22, 2014
(86) PCT No.: PCT/US2014/056709

§ 371 Date: Mar. 7, 2016

Related U.S. Application Data
(60) Provisional application No. 61/886,099, filed on Oct. 3, 2013.

(51) Int. Cl. F01D 9/04

(52) U.S. Cl. CPC F01D 9/041; F05D 2220/32; F05D 2240/122; F05D 2240/80

(57) ABSTRACT

A vane for use in a gas turbine engine has an airfoil extending between a leading edge and a trailing edge, a radially outer platform and a radially inner platform. A rib is on one of the radially inner and radially outer platforms, and is adjacent the trailing edge of the airfoil. A mid-turbine frame is also disclosed.

### CROSS-REFERENCE TO RELATED APPLICATION

This application claims priority to U.S. Provisional Application 61/886,099, filed Oct. 3, 2013.

### BACKGROUND OF THE INVENTION

This application relates to a vane for use as a static element in a gas turbine engine, wherein a platform is provided with a rib.

Gas turbine engines are known, and typically include a compressor delivering air into a combustion section where it is mixed with fuel and ignited. Products of this combustion pass downstream over turbine rotors, driving them to rotate. Static vanes are often positioned between adjacent turbine rotors and serve to redirect flow such that it is in a desired condition when it reaches a downstream turbine rotor.

One such location is a mid-turbine frame positioned between a higher pressure turbine rotor and a lower pressure turbine rotor. A mid-turbine frame typically includes vanes having a radially outer platform and a radially inner platform and an airfoil extending between the two platforms. The vanes are subject to a number of stresses, and designing the vanes to address those stresses is challenging.

### SUMMARY OF THE INVENTION

In a featured embodiment, a vane for use in a gas turbine engine has an airfoil extending between a leading edge and a trailing edge, a radially outer platform and a radially inner platform. A rib is on one of the radially inner and radially outer platforms, and is adjacent the trailing edge of the airfoil.

In another embodiment according to the previous embodiment, at least one platform is the radially outer platform.

In another embodiment according to any of the previous embodiments, the rib is on an outer surface of the outer platform and is spaced beyond the trailing edge relative to the leading edge.

In another embodiment according to any of the previous embodiments, the airfoil has a trailing edge at an inner surface of the outer platform. The rib is aligned with a fillet merging into the trailing edge at the inner surface.

In another embodiment according to any of the previous embodiments, the rib has a height extending radially outwardly that is greater than surrounding nominal wall portions.

In another embodiment according to any of the previous embodiments, the height of the rib is defined from an inner surface of the outer platform to a radially outermost face of the rib. The nominal wall thickness of the outer platform is defined between the inner surface and an outer surface of the outer platform. A ratio of the nominal wall thickness to the height is between 1.1 and 6.0.

In another embodiment according to any of the previous embodiments, a width of the rib is defined in a direction between the leading edge and the trailing edge. A ratio of the nominal wall thickness to the width is between 1.1 and 6.0.

In another embodiment according to any of the previous embodiments, a width of the rib is defined in a direction between the leading edge and the trailing edge, and a nominal wall thickness of the inner and outer surfaces of the outer platform is defined. A ratio of the nominal wall thickness to the width is between 1.1 and 6.0.

In another embodiment according to any of the previous embodiments, the rib is circumferentially continuous, and passes across a plurality of the airfoils.

In another embodiment according to any of the previous embodiments, the rib is circumferentially discontinuous, and there are gaps between rib portions.

In another embodiment according to any of the previous embodiments, the vane is a turbine vane.

In another featured embodiment, a mid-turbine frame has a radially inner and a radially outer platform. Airfoils extend between a leading edge and a trailing edge, and are generally hollow. A rib is on one of the radially inner and radially outer platforms. The rib is adjacent the trailing edge of the airfoil.

In another embodiment according to the previous embodiment, at least one platform is the radially outer platform.

In another embodiment according to any of the previous embodiments, the rib is on an outer surface of the outer platform and is spaced beyond the trailing edge relative to the leading edge.

In another embodiment according to any of the previous embodiments, the airfoil has a trailing edge at an inner surface of the outer platform. The rib is aligned with a fillet merging into the trailing edge at the inner surface.

In another embodiment according to any of the previous embodiments, the rib has a height extending radially outwardly that is greater than surrounding nominal wall portions.

In another embodiment according to any of the previous embodiments, the height of the rib is defined from an inner surface of the outer platform to a radially outermost face of the rib. A nominal wall thickness of the outer platform is defined between the inner surface and an outer surface of the outer platform. A ratio of the nominal wall thickness to the height is between 1.1 and 6.0.

In another embodiment according to any of the previous embodiments, a width of the rib is defined in a direction between the leading edge and the trailing edge. A ratio of the nominal wall thickness to the width is between 1.1 and 6.0.

In another embodiment according to any of the previous embodiments, the rib is circumferentially continuous, and passes across a plurality of the airfoils.

In another embodiment according to any of the previous embodiments, the rib is circumferentially discontinuous, and there are gaps between rib portions.

These and other features may be best understood from the following drawings and specification, the following which is a brief description.

### BRIEF DESCRIPTION OF THE DRAWINGS

FIG. 1 schematically shows a gas turbine engine.

FIG. 2 shows a mid-turbine frame.

FIG. 3A shows a first embodiment.

FIG. 3B shows a potential alternative embodiment, but taken generally along line B-B of FIG. 3A.

FIG. 4A is a cross-section along line B-B as shown in FIG. 3A.

FIG. 4B is a detail of a portion of FIG. 4A.

FIG. 4C shows an alternative embodiment.

FIG. 5 shows another alternative embodiment.

### DETAILED DESCRIPTION

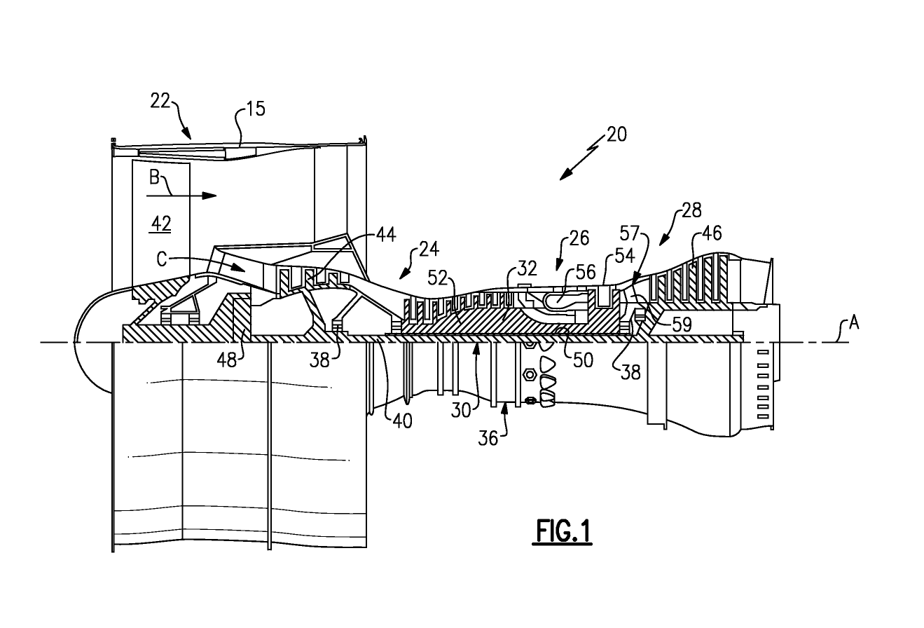

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (low) pressure compressor 44 and a first (low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (high) pressure compressor 52 and second (high) pressure turbine 54. The high pressure turbine 54 is upstream of the low pressure turbine 46. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

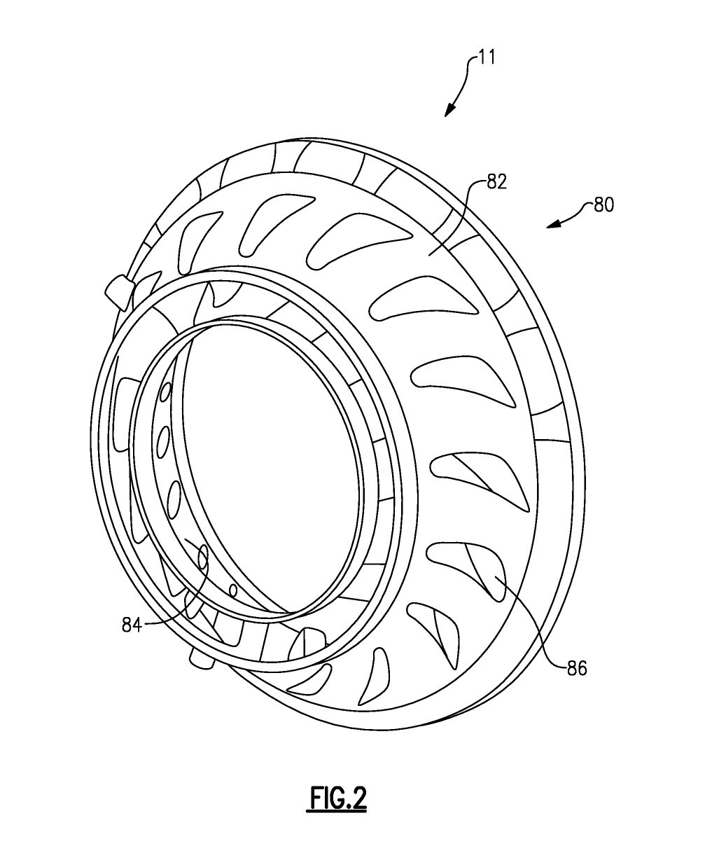

FIG. 2 shows a mid-turbine frame 11 formed of plural vanes 80, which may be utilized in the engine 20 at the location of mid-turbine frame 57 and may support a bearing 38. While a mid-turbine frame 11 having vanes 80 is shown incorporating details of this application, it should be understood that the features of this application can extend to any other location for turbine vanes. The application may also extend to compressor vanes. The vane 80 has a radially outer platform 82, and a radially inner platform 84. A plurality of airfoils 86 (airfoils 86 can be positioned like airfoils 59 as seen in FIG. 1), which are hollow, extend between the platforms 82 and 84.

A vane 80 could be defined as one airfoil 86, and a portion of the outer platform 82, and the inner platform 84. While this application discloses vanes connected together to surround a circumference, its teachings could extend to a single vane, and of course to a plurality of vanes connected together.

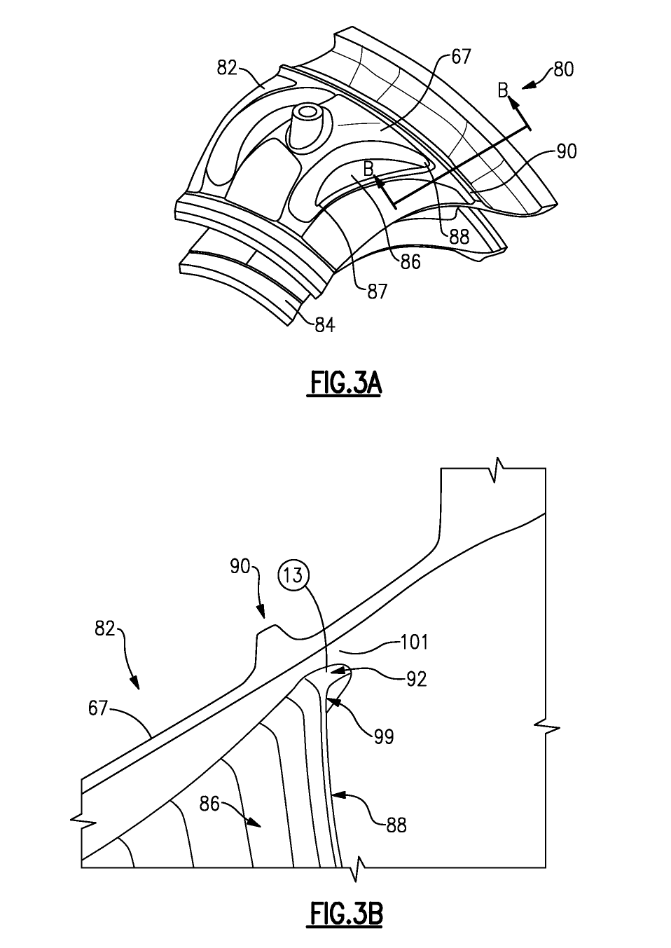

As shown in FIG. 3A, a first embodiment mid turbine frame 80 has the outer platform 82 including a plurality of airfoils 86 extending to the inner platform 84. An airfoil leading edge 87 and a trailing edge 88 of the airfoil 86 are defined at the outer surface 67 of the outer platform 82.

There are particular stresses at a location just beyond the trailing edge 88. The airfoils have a “bow” where they meet end walls, such as point 13 in FIG. 3B. There is a potential for high stress, in particular at the trailing edge and point 13. Thus, a rib 90 is formed adjacent the trailing edge 88, and in the FIG. 3A embodiment, just spaced away from the trailing edge in a direction away from the leading edge 87. As can be appreciated, the rib 90 is circumferentially continuous and extends circumferentially across at least a plurality of airfoils 86. The rib 90 provides a thermal mass and compressive stress to the region, thus assisting the mid turbine frame 80 in better adapting to the stresses and challenges mentioned above. In addition, the rib 90 can increase castability by assisting the flow of molten material into a trailing edge area of airfoil 86. The rib 90 is thicker than surrounding nominal wall portions.

As shown in FIG. 3B, the rib 90 may be positioned axially forward of a fillet 92 which merges a wall 99 of the airfoil 86 into the radially inner surface 101 of the outer platform 82. Thus, while the rib 90 may be spaced away from the trailing edge 88 at outer face 67 of the outer platform 82, it may be axially aligned with the inner fillet 92.

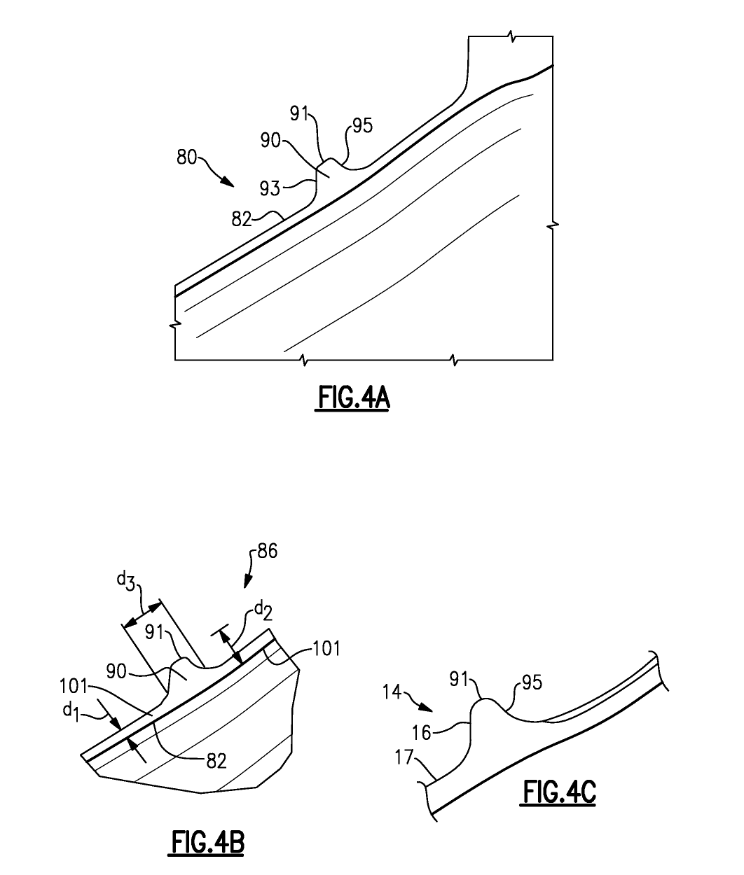

FIG. 4A is a cross-sectional view along the line 4-4 of FIG. 4A. As shown, the rib 90 extends to a radially outer face 91. An axially rear or trailing side 95 of the rib 90 extends generally more perpendicularly than does a leading edge side 93. The leading edge side 93 increases to the face 91 more gradually than does the trailing side 95.

FIG. 4B shows a nominal thickness d1 of the outer platform 82 wall. In one embodiment, the nominal wall thickness may be 0.080 in (0.203 cm). Further, a height d2 from the inner surface 101 to the top face 91 may be 0.350 in (0.889 cm) as cast. This thickness can be machined away to 0.250 in (0.635 cm) in in the final mid turbine frame 80. A width d3 of the rib may be 0.200 in (0.508 cm). In embodiments, a ratio of d1 to d2 was between 1.1 and 6.0, and a ratio of d1 to d3 was between 1.1 and 6.0.

FIG. 4C shows an alternative rib 14 wherein the upstream or leading edge side 16 is generally vertical to engine axis.

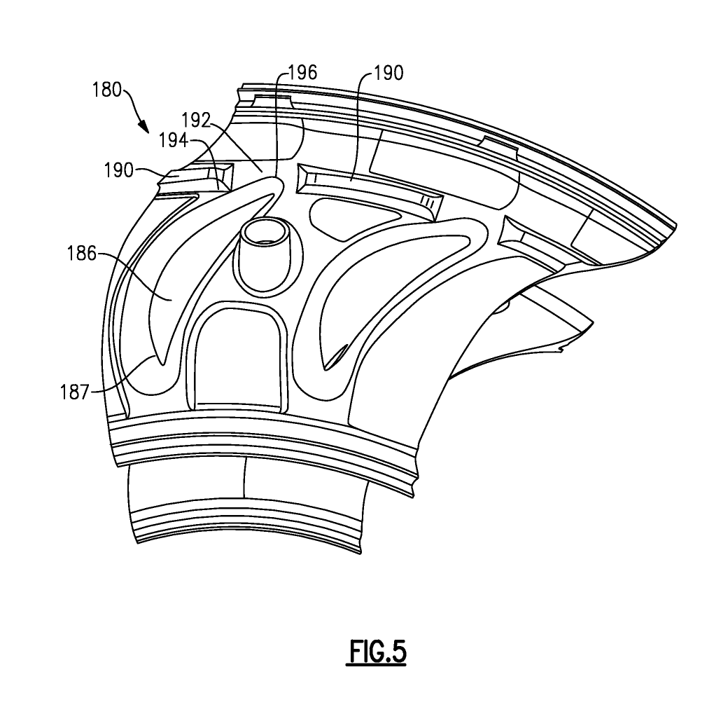

FIG. 5 shows an alternative embodiment 180, wherein the ribs 190 are formed of discrete rib segments. There are circumferentially spaced portions 192 intermediate the ribs 190 which are not at the same thickness or height. As shown, the airfoils 186 extend to a trailing edge 196. An axially forward end 194 of ribs 190 is closer to the leading edge 187 than is the trailing edge 196. The embodiment 180 may reduce material, and thus part weight. The dimensions and ratios as mentioned above would also apply to this embodiment.

Rather than one large rib, it is also possible to have two smaller ribs.

Although embodiments have been disclosed, a worker of ordinary skill in the art would recognize that certain modifications will come up in a scope of this invention. For that reason, the following claims should be studied to determine the true scope and content.

1. A vane for use in a gas turbine engine comprising:
an airfoil extending between a leading edge and a trailing edge;
a radially outer platform and a radially inner platform; and
a rib on one of said radially inner and radially outer platforms, and said rib being adjacent said trailing edge of said airfoil.

2. The vane as set forth in claim 1, wherein said at least one platform is said radially outer platform.

3. The vane as set forth in claim 2, wherein said rib is on an outer surface of said outer platform and spaced beyond said trailing edge relative to said leading edge.

4. The vane as set forth in claim 3, wherein said airfoil has a trailing edge at an inner surface of said outer platform, and said rib is aligned with a fillet merging into said trailing edge at said inner surface.

5. The vane as set forth in claim 1, wherein said rib having a height extending radially outwardly that is greater than surrounding nominal wall portions.

6. The vane as set forth in claim 5, wherein said height of said rib is defined from an inner surface of said outer platform to a radially outermost face of said rib, and said nominal wall thickness of said outer platform is defined between said inner surface and an outer surface of said outer platform, and a ratio of said nominal wall thickness to said height is between 1.1 and 6.0.

7. The vane as set forth in claim 6, wherein a width of said rib is defined in a direction between said leading edge and said trailing edge, and a ratio of said nominal wall thickness to said width is between 1.1 and 6.0.

8. The vane as set forth in claim 2, wherein a width of said rib is defined in a direction between said leading edge and said trailing edge, and a nominal wall thickness of the inner and outer surfaces of said outer platform is defined, and a ratio of said nominal wall thickness to said width is between 1.1 and 6.0.

9. The vane as set forth in claim 2, wherein said rib is circumferentially continuous, and passes across a plurality of said airfoils.

10. The vane as set forth in claim 2, wherein said rib is circumferentially discontinuous, and there are gaps between rib portions.

11. The vane as set forth in claim 1, wherein said vane is a turbine vane.

12. A mid-turbine frame comprising:
a radially inner and a radially outer platform;
airfoils extending between a leading edge and a trailing edge, and being generally hollow; and
a rib on one of said radially inner and radially outer platforms, and said rib being adjacent said trailing edge of said airfoil.

13. The frame as set forth in claim 12, wherein said at least one platform is said radially outer platform.

14. The frame as set forth in claim 13, wherein said rib is on an outer surface of said outer platform and spaced beyond said trailing edge relative to said leading edge.

15. The frame as set forth in claim 14, wherein said airfoil has a trailing edge at an inner surface of said outer platform, and said rib is aligned with a fillet merging into said trailing edge at said inner surface.

16. The frame as set forth in claim 12, wherein said rib having a height extending radially outwardly that is greater than surrounding nominal wall portions.

17. The frame as set forth in claim 16, wherein said height of said rib is defined from an inner surface of said outer platform to a radially outermost face of said rib, and a nominal wall thickness of said outer platform is defined between said inner surface and an outer surface of said outer platform, and a ratio of said nominal wall thickness to said height is between 1.1 and 6.0.

18. The frame as set forth in claim 17, wherein a width of said rib is defined in a direction between said leading edge and said trailing edge, and a ratio of said nominal wall thickness to said width is between 1.1 and 6.0.

19. The frame as set forth in claim 12, wherein said rib is circumferentially continuous, and passes across a plurality of said airfoils.

20. The frame as set forth in claim 12, wherein said rib is circumferentially discontinuous, and there are gaps between rib portions.
